(19) United States
(12) Patent Application Publication
(10) Pub. No.: US 2014/0324399 A1
(43) Pub. Date: Oct. 30, 2014

(54) Method and System for Determining Fluid Flow of Compressible and Non-Compressible Liquids

(71) Applicant: UNIVERSITY OF WINDSOR, Windsor (CA)

(72) Inventors: Ronald BARRON, St. Clair Beach (CA); Yi WANG, Windsor (CA)

(73) Assignee: UNIVERSITY OF WINDSOR, Windsor (CA)

(21) Appl. No.: 14/207,027

(22) Filed: Mar. 12, 2014

Related U.S. Application Data
(63) Continuation-in-part of application No. 13/455,586, filed on Apr. 25, 2012.
(60) Provisional application No. 61/783,107, filed on Mar. 14, 2013.
(60) Provisional application No. 61/457,589, filed on Apr. 26, 2011.

(51) Int. Cl. G06F 17/50

(52) U.S. Cl. CPC G06F 17/5009
USPC 703/2

(57) ABSTRACT

A system and method for determining fluid flow of compressible and non-compressible liquids is described. The system may include input means for receiving a model of an object defined as a plurality of cells having a plurality of nodes P, and a processor coupled to a memory. The processor may be configured for: discretizing a partial differential equation (PDE) corresponding to the received model; for each node P: (i) locating all neighbouring cells that share the node P; (ii) grouping all of the neighbouring cells to form one larger cell having a common vertex at node P; (iii) approximating the PDE at the common vertex at node P using the discretized PDE; and iteratively updating the solution for all the nodes P from an initial guess until a convergence criterion is satisfied.

### RELATED APPLICATIONS

This application claims the benefit under 35 USC §119(e) to U.S. Provisional Application No. 61/783,107, filed on Mar. 14, 2013, the contents of which are hereby incorporated by reference in their entirety. This application also relates to commonly owned U.S. patent application Ser. No. 13/455,586, filed on Apr. 25, 2012, which claims the benefit under 35 USC §119(e) to U.S. Provisional Application No. 61/457,589.

### FIELD OF THE INVENTION

This invention relates to a system and method for modeling internal and/or boundary conditions, as for example to model or determine fluid flows in, around and/or across objects or structures and, in particular, for both compressible and non-compressible liquids.

### BACKGROUND OF THE INVENTION

Computer methods and algorithms can be used to analyze and solve complex systems involving various forms of fluid dynamics having inputted boundary conditions. For example, computer modeling may allow a user to simulate the flow of air and other gases over an object or model the flow of fluid through a pipe. Computational fluid dynamics (CFD) is often used with high-speed computers to simulate the interaction of one or more fluids over a surface of an object defined by certain boundary conditions. Typical, methods involve large systems of equations and complex computer modeling and include traditional finite difference methodology, cell-centered finite volume methodology and vertex-centered finite volume methodology.

### Traditional Finite Difference Methodology

Traditional Finite Difference Methodology (TFDM) requires a structured grid system, a rectangular domain and uniformed grid spacing. TFDM cannot be applied on a mesh system with triangular cells (elements). Rather, cells must be quadrilateral (2D) and cannot be polygonal (i.e., number of sides=4). In 3D, cells must be rectangular cubes.

TFDM typically requires the use of coordinate transformations (i.e., grid generation) for curvilinear domains, to map the physical domain to a suitable computational domain. In addition, there may be a need to use a multiblock scheme if the physical domain is too complicated. Partial differential equations (PDEs) must be transformed to the computational domain.

Traditional Finite Difference Methodology is typically difficult to deal with in complicated grid arrangements. Special treatment may be required near boundaries of the domain (e.g., in staggered grid systems or for higher-order schemes). Even with coordinate transformations, highly irregular domains may create serious difficulties for accuracy and convergence due to numerical discontinuities in the transformation metrics.

### Cell-Centered Finite Volume Methodology/Vertex-Centered Finite Volume Methodology

Cell-Centered Finite Volume Methodology (CCFVM) and Vertex-Centered Finite Volume Methodology (VCFVM) achieve greater flexibility in grid arrangement. Cells can be polygonal (e.g., triangular) in 2 Dimensional space or polyhedral (e.g., tetrahedral, prismatic) in 3 Dimensional space. With CCFVM/VCFVM there is no need for coordinate transformations to a computational domain. Rather, all calculations can be done in physical space. As well, grid smoothness is not an issue. Cell-centered schemes evaluate the dependent variable at the centroid of each cell. Vertex-centered (or vertex-based) schemes evaluate the dependent variable at the vertices of each cell.

With CCFVM/VCFVM, inaccuracies due to calculation of fluxes across cell faces may be difficult to deal with. In addition, there are difficulties associated with treatment near boundaries for higher-order schemes, and accuracy and convergence issues associated with cells that are severely skewed or have a high aspect ratio.

Accordingly, current computer modeling schemes are limited in the form of objects they can model and require different models and algorithms for different fluid applications, such as between compressible and non-compressible fluids.

### SUMMARY OF THE INVENTION

It is an object of this invention to provide a better method and system for determining and/or modeling boundary conditions, as for example, to determine or compute fluid dynamics of compressible and non-compressible liquids in, around or across objects. In one particular embodiment, it is an object of this invention to provide a better method and system to compute the fluid dynamics of compressible liquids in aeronautical application, the aeronautical applications having certain boundary conditions.

Furthermore, another object of this invention to provide a better method and system for computing the fluid dynamics of non-compressible liquids within a pipe or transport mechanism, the pipe or transport mechanism having certain boundary conditions.

The inventors have appreciated that if the solution domain can be discretized into a smooth structured grid, finite difference methodology (FDM) is better than finite volume methodology (FVM) or finite element methodology (FEM) due to its efficiency. In particular, an FDM method requires less memory and has better stability. Furthermore, a system and method relying on an FDM has better convergence properties.

One approach, which uses a vertex-centered finite difference method (VCFDM), described hereafter, lies in the discovery and development of a unified scheme for the numerical solution of Partial Differential Equations (PDEs), irrespective of their physical origin. This approach is based on the finite difference method, but is implemented in an innovative fashion that allows the use of an arbitrary mesh topology. Thus, the VCFDM enjoys the simplicity and strength of the traditional FDM, and the power and flexibility of the FVM and FEM.

A program, which utilizes the VCFDM may evolve into entirely new multiphysics computational continuum mechanics software, or replace the core numerical processing component of some existing software packages. The VCFDM uses a much simpler and more efficient algorithm which permits a natural and seamless coupling of fluid and solid interaction, allows for a more precise analysis of accuracy, and may produce faster, more accurate and/or more reliable results.

In one aspect, the present invention resides in a system for modeling internal and/or boundary conditions and more preferably, for determining fluid flow of compressible and non-compressible liquids, as for example, in, around or across an object or structure.

The system may include input means for receiving a model of an object defined as a plurality of cells having a plurality of nodes P and a processor coupled to a memory. The processor may be configured for implementing the steps of discretizing a partial differential equation corresponding to the received model of the object; for each node P in the plurality of nodes P: (i) locating all neighbouring cells that share the node P; (ii) grouping two or more, and preferably substantially all of the neighbouring cells to form at least one larger cell having a common vertex at node P; (iii) approximating the partial differential equation at the common vertex at node P using the discretized partial differential equation; and iteratively updating the solution for all the nodes P from an initial guess until a convergence criterion is satisfied.

In another aspect, the present invention resides in a computer-implemented method for approximating a partial differential equation for determining fluid flow of compressible and non-compressible liquids. The method comprising: discretizing the partial differential equation; receiving a model of the object defined as a plurality of cells having a plurality of nodes P; for each node P in the plurality of nodes P: (i) locating all neighbouring cells that share the node P, (ii) grouping two or more and preferably all of the neighbouring cells to form one larger cell having a common vertex at node P; (iii) approximating the partial differential equation at the common vertex at node P using the discretized partial differential equation; and iteratively updating the solution for all the nodes P from an initial guess until a convergence criterion is satisfied.

In yet another aspect, the present invention resides in a computer readable medium having instructions stored thereon that when executed by a computer implement a method for approximating a partial differential equation for determining fluid flow of compressible and non-compressible liquids. The method may include discretizing the partial differential equation; receiving a model of an object defined as a plurality of cells having a plurality of nodes P; for each node P in the plurality of nodes P: (i) locating all neighbouring cells that share the node P, (ii) grouping two or more, and more preferably all of the neighbouring cells to form a larger cell having a common vertex at node P; (iii) approximating the partial differential equation at the common vertex at node P using the discretized partial differential equation; and iteratively updating the solution for all the nodes P from an initial guess until a convergence criterion is satisfied.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings, in which:

FIG. 1 shows schematically a system for modeling of flow dynamics using a computer system in accordance with a preferred embodiment of the present invention;

FIG. 2 shows schematically the architecture of the computer system shown in FIG. 1 used in the modeling of flow dynamics in accordance with an embodiment of the present invention;

FIG. 3 shows schematically a flowchart for modeling flow dynamics in accordance with a preferred embodiment of the present invention;

FIG. 4 shows a flowchart for the step of modeling fluid flow about an object shown in

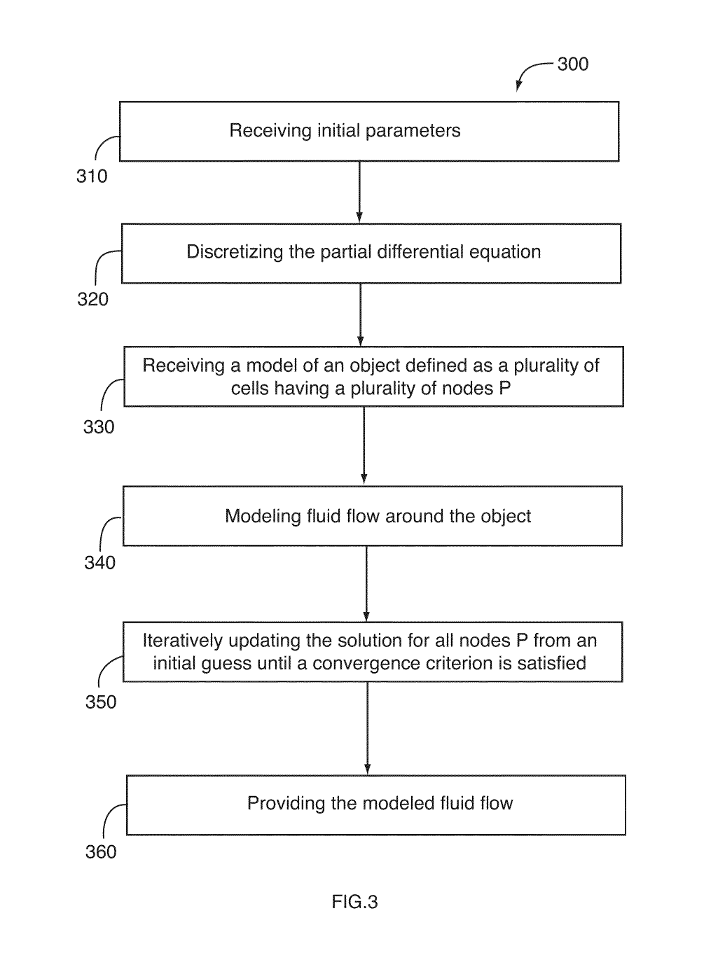

FIG. 3, using CCFDM methodology;

FIG. 5 shows schematically an exemplary 2-D model containing a generic node P, cells, and cell centroids in accordance with modeling approaches using CCFDM methodology;

FIG. 6 shows an exemplary 2-D model of a mesh of cells for a boundary region on an object for use in accordance with modeling approaches using a preferred embodiment of the present invention;

FIG. 7 shows the 2-D model of FIG. 6 illustrating the selection of nodes P and Q for use in accordance with modeling approaches using a preferred embodiment of the present invention;

FIG. 8 shows the 2-D model of FIG. 7 illustrating cell centroids in accordance with a preferred modeling approach using CCFDM methodology;

FIG. 9 shows the 2-D model of FIG. 8 illustrating the stenciling of cell centroids in accordance with modeling approaches using CCFDM methodology;

FIG. 10 shows schematically a transformation of a cell center from a physical space (x, y) to a computational space (ζ, η) in accordance with modeling approaches using CCFDM methodology;

FIG. 11 shows a generic three dimensional cell for a three dimensional model, in accordance with modeling approaches using CCFDM methodology.

FIG. 12 shows a flowchart for the step of modeling fluid flow about an object shown in FIG. 3, in accordance with an alternate embodiment of the present invention

FIG. 13 shows schematically an exemplary 2-D model containing generic node P, cells, and stencil, in accordance with modeling approaches using the alternate methodology of FIG. 12;

FIG. 14 shows an exemplary 2-D model of a mesh of cells for a boundary region on an object, containing selected nodes P and Q, and stencil, for use in accordance with an alternate embodiment of the present invention; and

FIG. 15 shows a generic three dimensional cell for a three dimensional model, in accordance with modeling approaches using an alternate embodiment of the present invention.

### DETAILED DESCRIPTION OF THE PREFERRED EMBODIMENTS

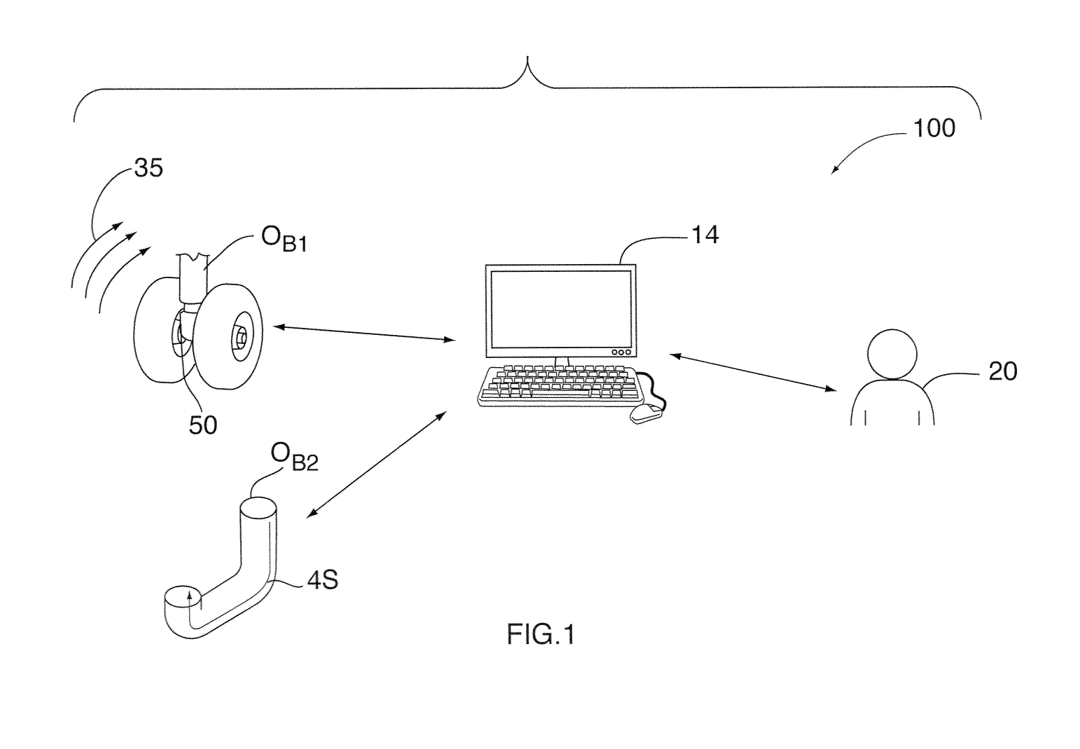

FIG. 1 illustrates schematically a system 100 for determining fluid flow of compressible and non-compressible fluids in accordance with at least one embodiment. The system 100 includes a computer 10 which is adapted to provide a user 20 with data output on a display, which simulates fluid flow dynamics through or around a physical boundary defining object (O_{B}). User 20 may enter modeling parameters such as, for example, computer aided design (CAD) models of objects O_{B}, boundary conditions and/or initial conditions. Such objects O_{B} may include, without limitation, objects such as aircraft landing gear O_{B1} or a pipeline O_{B2}. The fluid flow dynamics may relate to a compressible fluid, such as airflow 35, passing near to, through or over the landing gear O_{B1}, or other non-compressible fluids, such as liquid 45, passing near to, through, or over a pipeline O_{B2}. One or more sensors 50 may measure conditions such as, for example, fluid flow, temperature, velocity, particulate matter, or viscosity.

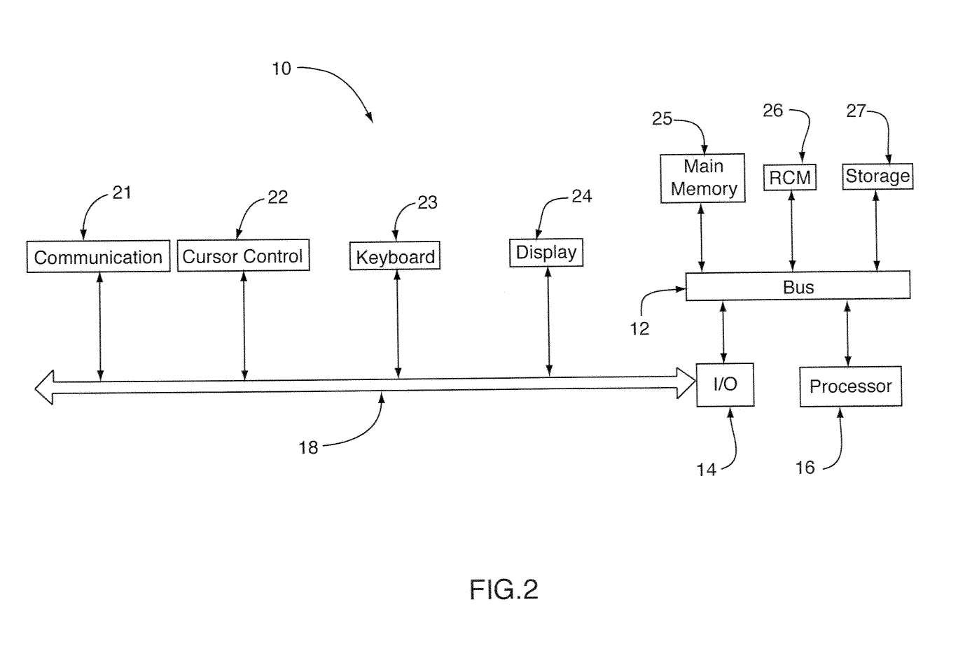

FIG. 2 illustrates schematically the architecture of the computer system 10 which may be used to implement a preferred embodiment of the present invention. The computer system 10 includes a system bus 12 for communicating information, and a processor 16 coupled to the bus 12 for processing information.

The computer system 10 further comprises a random access memory (RAM) or other dynamic storage device 25 (referred to herein as main memory), coupled to the bus 12 for storing information and instructions to be executed by processor 16. Main memory 25 may also be used for storing temporary variables or other intermediate information during execution of instructions by the processor 16. The computer system 10 may also include a read only memory (ROM) and/or other static storage device 26 coupled to the bus 12 for storing static information and instructions used by the processor 16.

A data storage device 27 such as a magnetic disk or optical disc and its corresponding drive may also be coupled to the computer system 10 for storing information and instructions. The computer system 10 can also be coupled to a second I/O bus 18 via an I/O interface 14. A plurality of I/O devices may be coupled to the I/O bus 18, including a display device 24, an input device (e.g., an alphanumeric input device 23 and/or a cursor control device 22), and the like. A communication device 21 is used for accessing other computers (servers or clients) via an external data network (not shown). The communication device 21 may comprise a modem, a network interface card, or other well-known interface devices, such as those used for coupling to Ethernet, token ring, or other types of networks.

FIG. 3 illustrates schematically a method for modeling fluid flow dynamics around a boundary object in accordance with the present invention. At 310, initial parameters are received from user 20 or from sensors 50. The initial parameters may include initial conditions and boundary conditions, which constrain the model, as well as convergence criteria. At 320, a system of partial differential equations based on the initial parameters is discretized. At 330, a CAD representation or profile of a boundary object is received. At 340, system 10 models the fluid flow around the boundary defining object by solving the system of partial differential equations until a convergence criterion is satisfied at 350. At 360, a solution, which may be in the form of a simulation, is provided to the user.

### Exemplary Embodiment #1

### Compressible Fluids

In a preferred embodiment, computer system 10 is used in conjunction with compressible fluid flow data to model the fluid dynamics around a boundary object, such as an aircraft landing gear moving through the air, for example during aircraft landing or flight. In use of the system 10, a CAD representation of the aircraft landing gear and supporting structure is inserted into the model.

Airflow, as a compressible fluid, may be constrained by initial conditions entered as part of the model or taken from sensors from real-world applications. The airflow may be modeled as a partial differential equation, as known in the art of fluid dynamics. Data from temperature and speed sensors, taken from real-world applications, may be included in the model.

Once the boundary conditions and initial conditions have been inputted, the profile is input into the system 10 of the present invention and when the solution converges to a steady state, the solution is outputted. The solution may describe the flow of compressible fluid for the specific boundary conditions and initial conditions inputted into the model.

The system advantageously allows a user to determine and analyze the turbulence in the compressible fluid caused by the different aircraft components passing through the airflow. The steady state output can be used to identify and analyze different flow regimes, such as laminar flow and turbulent flow including eddies, vortices and other flow instabilities. In addition, the behaviour of the fluid about the boundary layer is also provided. In particular, the noise of the flow over the aircraft component can be provided including the frequency of any noise created.

It should be understood that the system 10 is capable of modeling any type of compressible fluid through a wide variety of applications, as further discussed below. Besides modeling the air passing over an aircraft component, other applications may include engine design, wind-tunnel effects and other airflow applications. In addition, the compressible fluid may be in a confined space, such as within a tunnel, or in a non-confined space, such as in flight.

### Exemplary Embodiment #2

### Non-Compressible Fluids

The above-described computer system 10 can also be used to model the fluid dynamics of a non-compressible fluid through a defined space. For example, in a preferred embodiment, the computer system 10 can model a fluid such as water through a pipe or other transport mechanism.

As with the compressible embodiment, described above, a computer-aided designed (CAD) representation of the pipe is inserted into the simulation. Typical boundary conditions may be represented in the model.

The system 10 then models the flow of the non-compressible fluid, i.e. water or gas, through the pipe in successive stages. The non-compressible fluid may be further defined by its initial conditions or parameters. For example, the non-compressible fluid may include particulate matter and have a specific viscosity. The non-compressible fluid may be constrained by initial conditions entered as part of the computer simulation or taken from sensors from real-world applications. These parameters may be inserted into the partial differential equation (PDE) used to model the compressible fluid flow. For example, flow and temperature data from real-world flow-analysis may be inputted automatically into the simulation.

Once the solution of the system of PDEs has converged to a steady state, the solution is provided. Prior to being provided, the output data is transformed into a usable format for describing the flow of the non-compressible fluid for the specific boundary conditions and initial conditions received by the computer system.

The simulation advantageously allows a user to determine and analyze the turbulence in the non-compressible fluid caused by the boundary conditions (i.e. the pipe). The steady state output provided in the simulation can be used to identify and analyze different flow regimes, such as laminar flow and turbulent flow including eddies, vortices and other flow instabilities. In addition, the behaviour of the fluid about the boundary layer is also provided. Furthermore, the simulation may model the aggregate (i.e the particulate matter) in the fluid and the Reynolds Number (Re).

It should be understood that the system 10 is capable of modeling any type of non-compressible fluid through a wide variety of applications. Besides simulating the flow of fluid passing through a pipe, other applications may include oil and gas applications and hydraulics.

### Comparison of Cell-Centered Finite Difference Methodology and Vertex-Centered Finite Difference Methodology

An alternate preferred method of solving partial differential equations (PDEs) using Vertex-Centred Finite Different methodology in accordance with the present invention is now described.

The Vertex-Centred Finite Difference Method (VCFDM) methodology is modified from the Cell-Centred Finite Difference Method (CCFDM) methodology disclosed in commonly owned U.S. application Ser. No. 13/455,586, filed on Apr. 25, 2012, the disclosure of which is hereby incorporated by reference in its entirety.

A key difference between the VCFDM and the CCFDM methods is the selection of the point at which discretization of a PDE or PDEs takes place. In the CCFDM methodology, the cell centroid (or some other convenient point inside each cell) is used. With VCFDM methodology, the cells are grouped together around a common vertex to form one larger cell, and the discretization process is applied at this common vertex. The main advantages of VCFDM over CCFDM are, for example: reduction in computational cost, reduction in storage requirements, reduction in memory usage, improved accuracy, and simpler coding.

To illustrate the present invention, the differences between CCFDM and VCFDM to solve a given PDE, or system of PDEs, on a mesh arrangement will now be described. The mesh arrangement is a two dimensional representation of a three dimensional boundary object, and contains individual elements (or cells).

### Cell-Centered Finite Difference Method

Reference is now made to FIG. 5 to illustrate the applicant's numerical approximation process using CCFDM. In one example, a given. Partial Differential Equation (PDE), or system of PDEs may be solved using a mesh arrangement containing elements or cells 510. Given the geometry of each cell, i.e. knowing the Cartesian coordinates of the cell vertices, the location of the cell centroids cc1, cc2, cc3, cc4, cc5, cc6, cc7 is determined. Then, a finite difference stencil 520 is constructed locally for each cell, the stencil being centred at the centroid. This stencil has the unique feature that it is confined to the cell, intersecting the boundary edges of each cell at points w, e, s and n.

For example, by examining the differencing stencil around cell centroid cc1, the distances from cc1 to e and w are shown as not equal. Similarly, the distances from cc1 to s and n are not equal. This inequality will degrade the accuracy of any central difference formula about the point cc1. To overcome this problem, 1D mappings are used from x to ζ and from y to η such that the line segment ‘w-cc1-e’ is mapped to a line segment −1≦ζ≦1 where cc1 is mapped to ζ=0. A similar mapping is used to map the line segment ‘s-cc1-n’ to −1≦η≦1, as is shown in FIG. 10.

The PDE, which will be applied at the cell centroid cc1, must also be transformed to the computational space. Consider, for example, the model elliptic equation (Poisson eqn.):

$$\frac{{\partial }^{2} T}{\partial {x}^{2}} + \frac{{\partial }^{2} T}{\partial {y}^{2}} = f ( x , y )$$

Under the 1D mappings x=x(ζ), y=y(η), this equation transforms to:

[symbol]

If one uses 3-point central differencing to approximate the partial derivatives in this equation, then the resulting difference equation can be written as:

a_{cc}T_{cc}=a_{w}T_{w}+aₑTₑ+aₛTₛ+aₙTₙ−f_{cc}

where the coefficients are expressed in terms of the physical Cartesian coordinates of the w, e, s and n points. This equation can be solved iteratively for the value of T at the cell centroid, assuming we have previous iteration values for T_{w}, Tₑ, Tₛ and Tₙ.

### Iterative Solution for CCFDM

Step 1: Create a mesh of cells for the boundary region on an object of interest. Label all nodes N0, N1, N2, etc. (FIG. 6). Establish a fixed reference frame Oxy. Line segments N1-N2, N2-N3, - - - , N6-N7 form the interface boundary curve between the solid material (solid region) and the fluid material (fluid region) depicted in this model. The mesh in the model can be arbitrary or user influenced, e.g., the user can apply a finer mesh (smaller size cells) in the areas of the model where variables have high gradients. The finer mesh will result in higher resolution in those areas.

Step 2: Select any node in the mesh, and determine the cells sharing that node. For example, as shown in FIG. 7, P is a node in the solid region and Q is a node in the fluid region. The cells surrounding P are P-N1-N4, P-N4-N6, P-N6-N7-N8-N9, etc. The cells surrounding Q are Q-N17-N24-N25, Q-N25-N26-N19, Q-N19-N6-N5 and Q-N5-N4-N17.

Step 3: For each cell surrounding P (or Q), determine the coordinates of the cell centroids cc1, cc2, etc. (FIG. 8).

Step 4: Within each cell surrounding P (or Q), create a stencil centred at the cell centroid with arms parallel to the x, y, coordinate directions defined by the fixed reference frame, intersecting the cell faces at points w, e, s and n. For example, for node P refer to the cell formed by nodes P-N13-N1 with cell centre cc1. For node Q refer to the cell formed by nodes Q-N17-N24-N25|. As an alternative to using cell centroids in Steps 3 and 4, it is possible to determine the coordinates of the point cc′ in the cell which has the property that the length of the line segments w-cc′ and cc′-e are equal and the length of the line segments s-cc′ and cc′-n are equal (FIG. 9).

Step 5: For each cell surrounding P (or Q), determine and store the coordinates of the face intersection points w, e, s and n.

Step 6: Repeat Steps 2-5 for all nodes in the mesh.

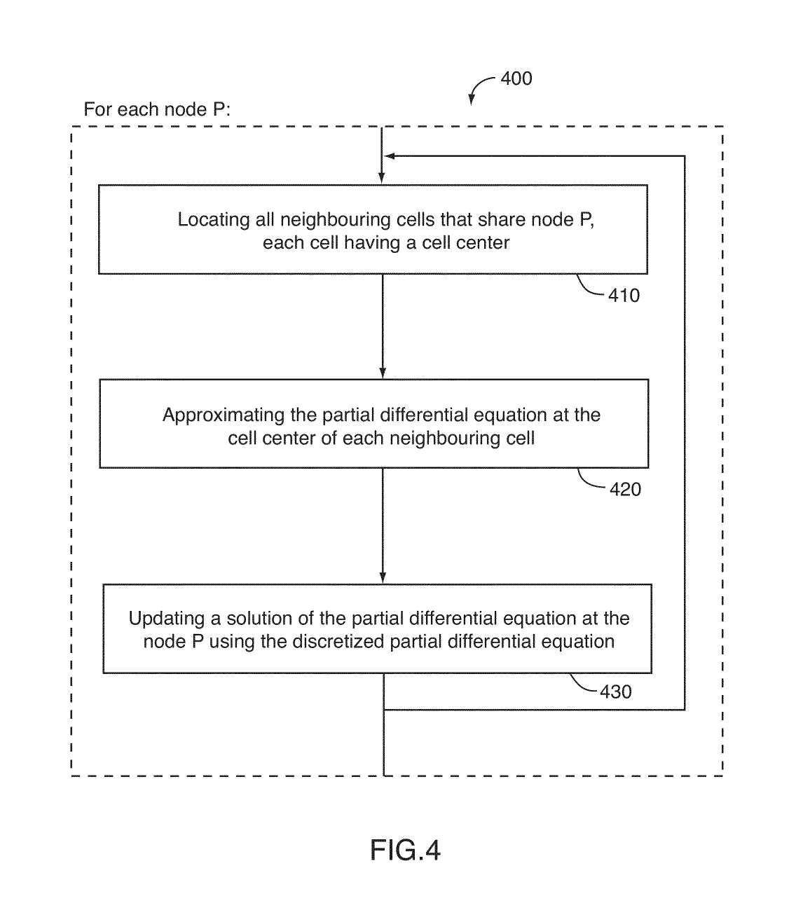

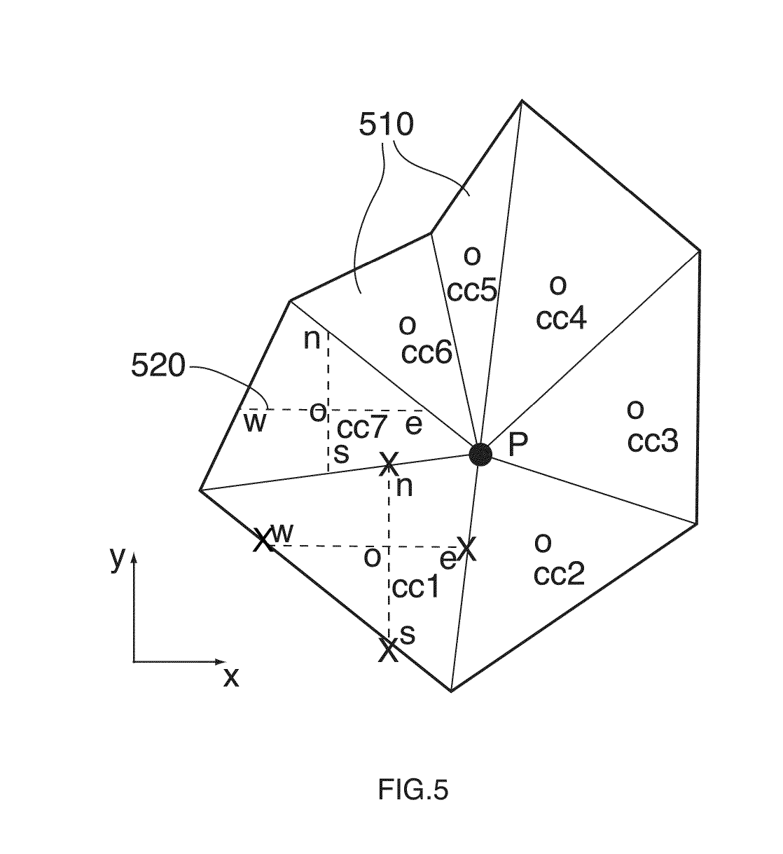

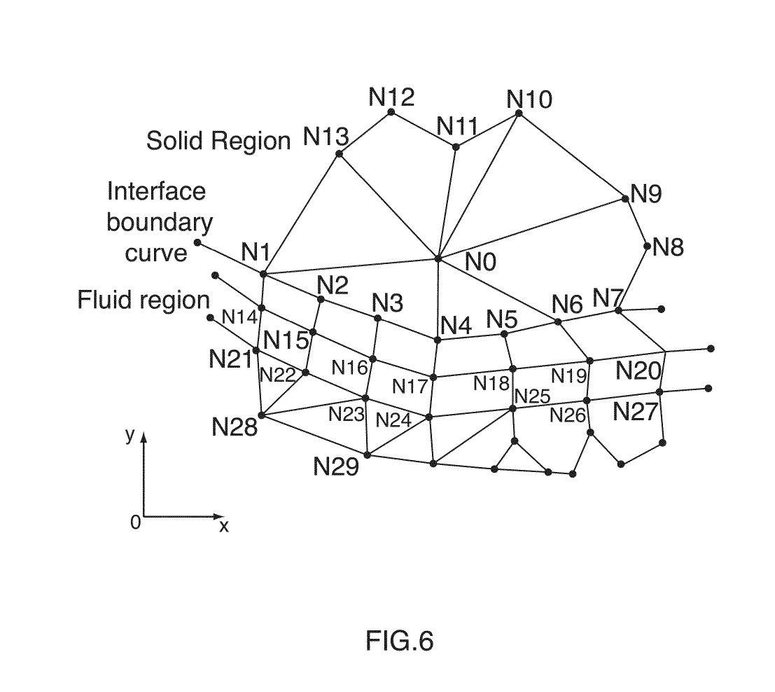

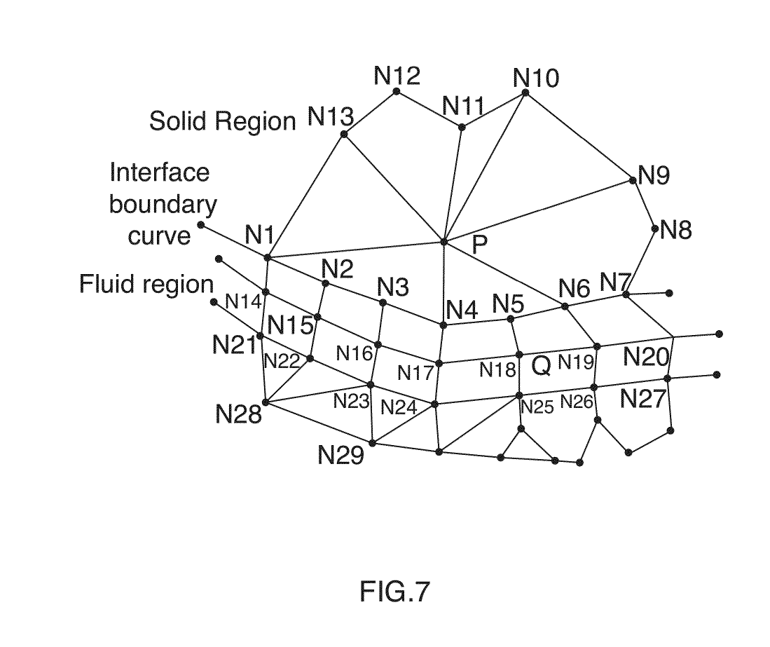

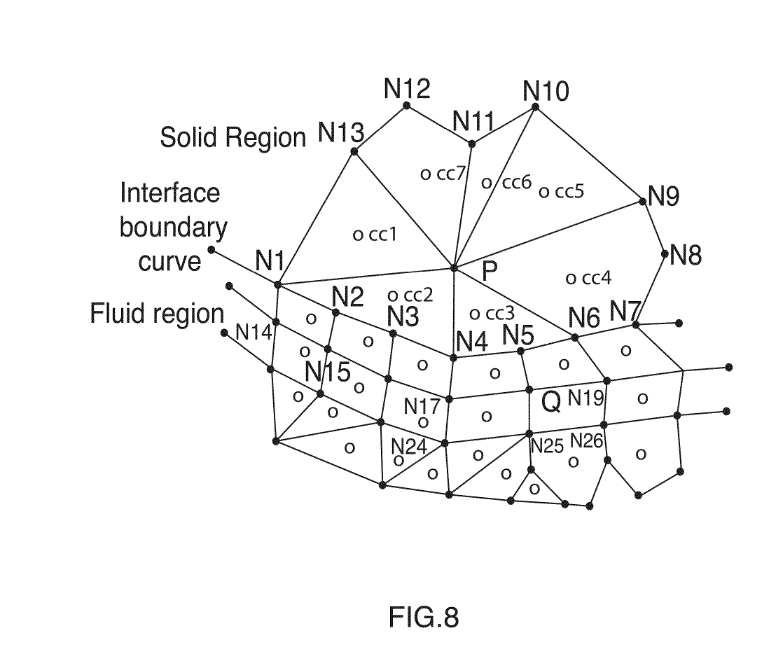

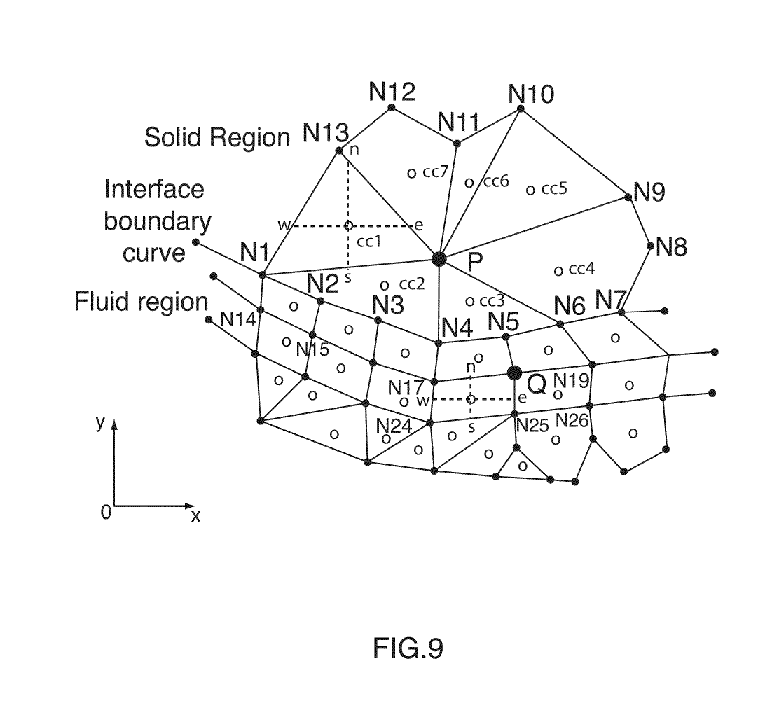

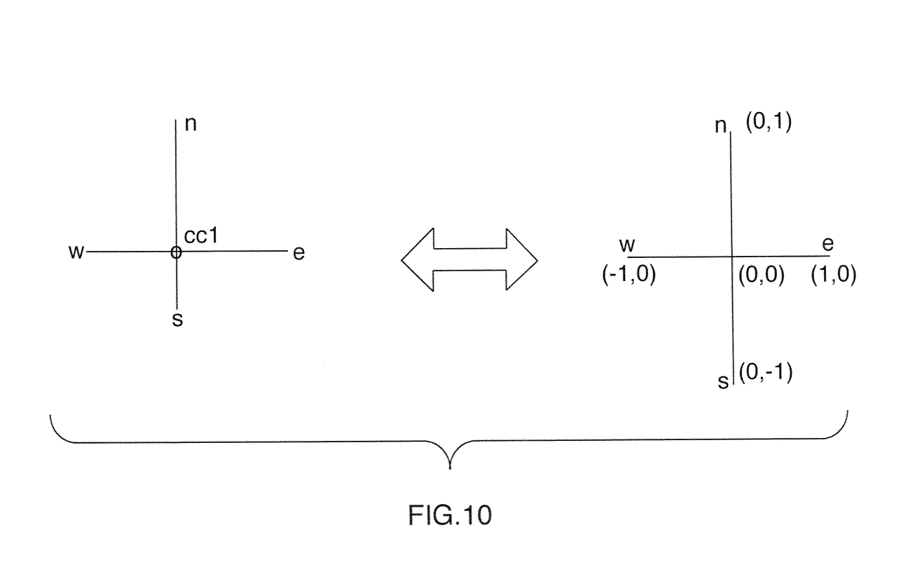

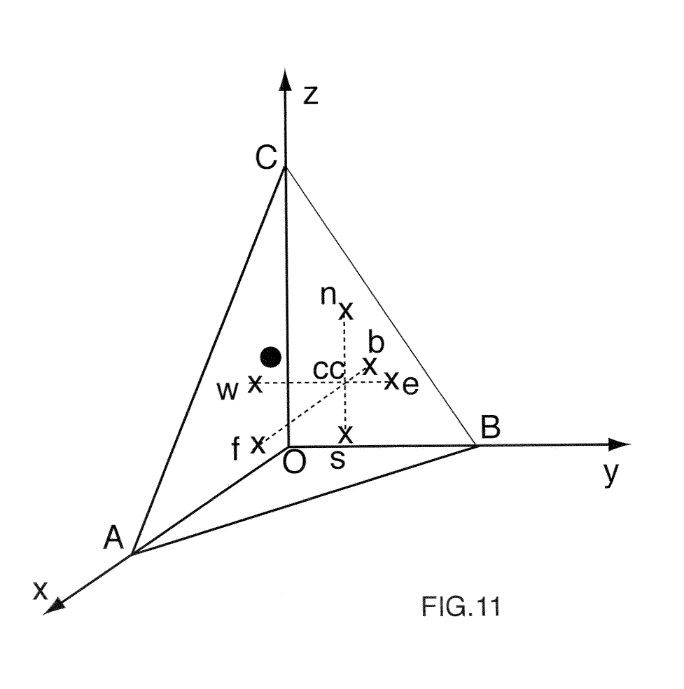

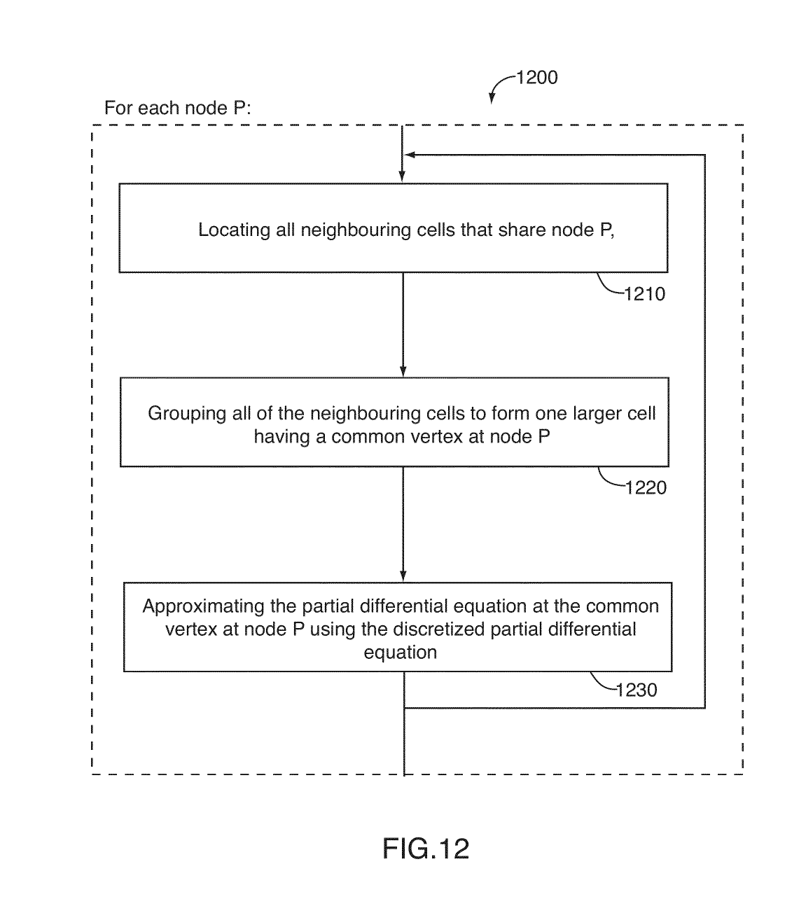

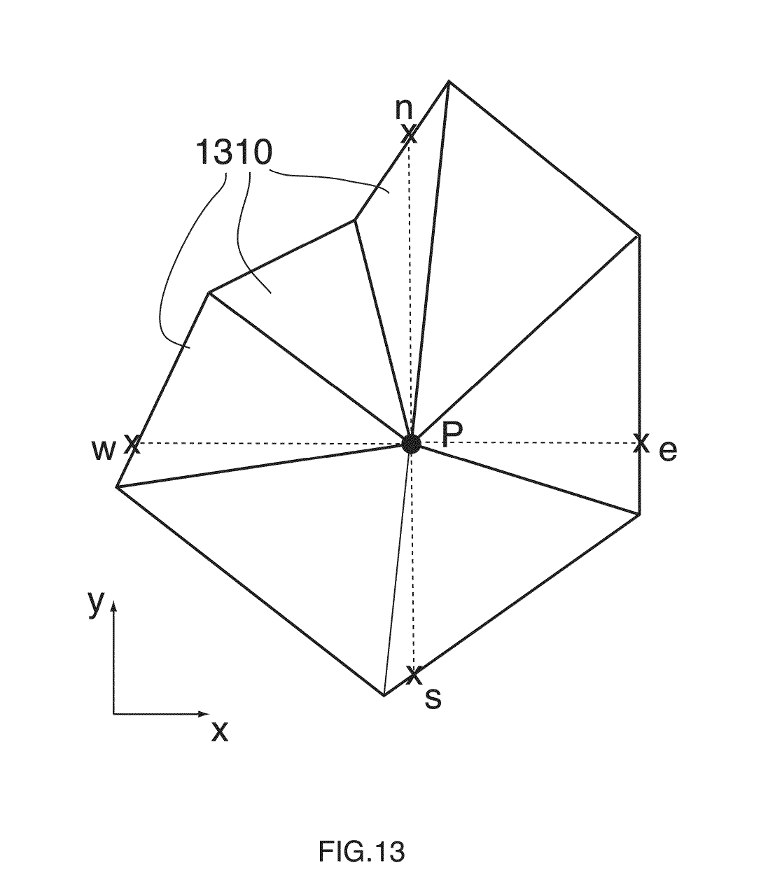

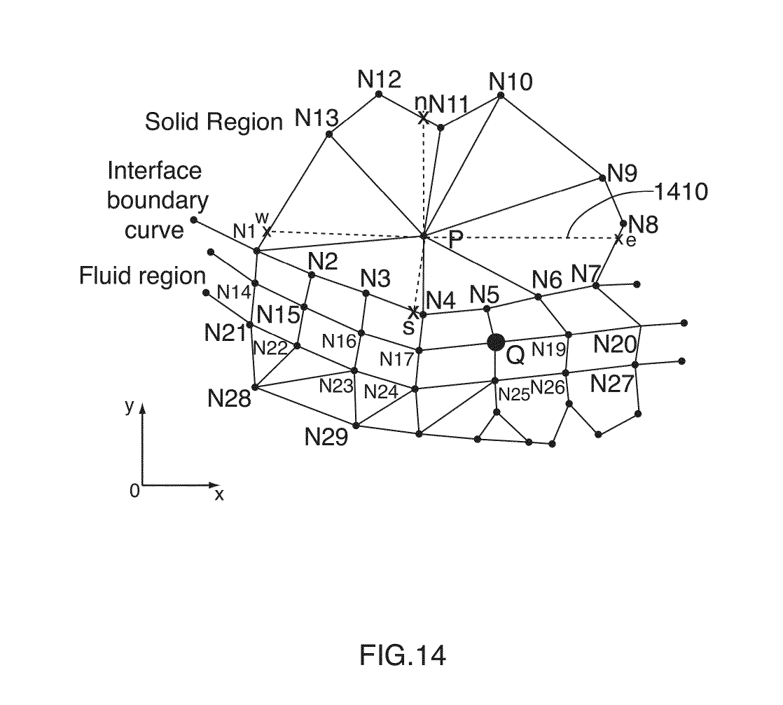

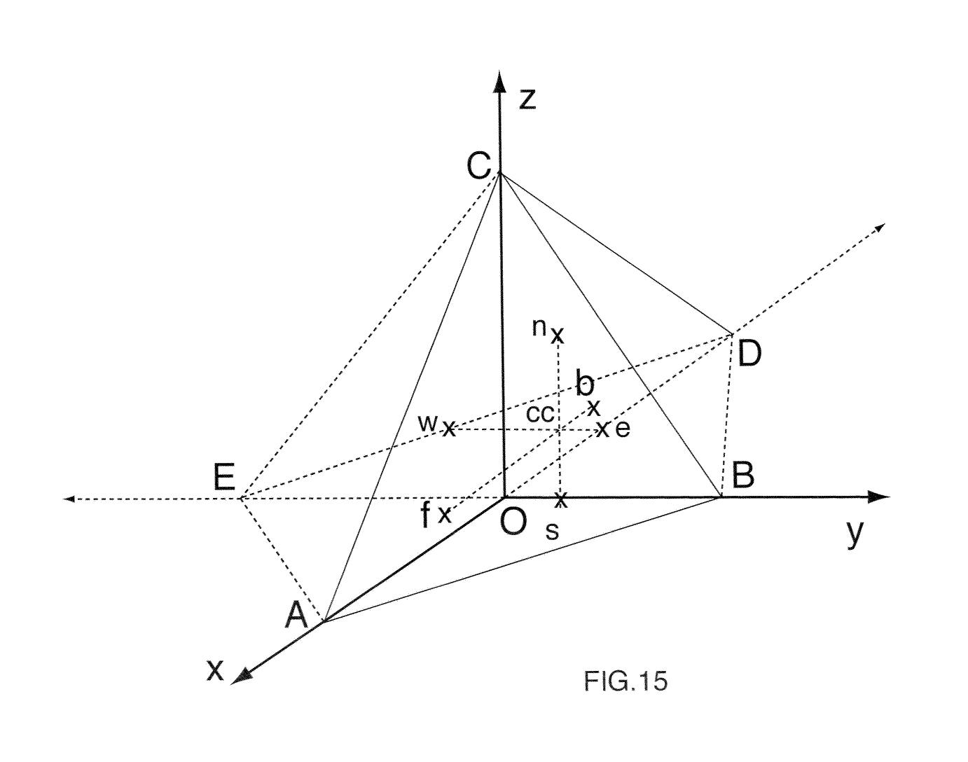

Step 7: Select a node P in the mesh at which the dependent variable (T) is to be evaluated, and collect all the cells surrounding P. This node P may be in the solid region, in the fluid region, or on the interface boundary curve (FIG. 4, 410).

Step 8: For each cell surrounding node P, apply the appropriate mathematical equation (e.g., PDE for solids, or PDE for fluids), defined by the medium in which the cell lies, at the cell centre (FIG. 4, 420). Approximate the continuous derivatives in the mathematical equations by standard finite difference formulae, applied on the stencils created in Step 4, to formulate a discrete approximation to the continuous equations (430). For each cell, this will result in a finite difference equation of the form:

a_{cc}T_{cc}+a_{w}T_{w}+aₑTₑ+aₛTₛ+aₙTₙ=S_{cc} (1)

if the cell is a solid cell, and of the same mathematical form as (1), namely

a_{cc}T_{cc}+a_{w}T_{w}+aₑTₑ+aₛTₛ+aₙTₙ=S_{cc} (2)

if the cell is a fluid cell. In equations (1) and (2) the subscripts cc, w, etc., refer to the cell centre, face intersection point w, etc. The coefficients a_{cc}, aₑ, aₛ, aₙ and the source term S_{cc} in equations (1) and (2) are not the same. These quantities depend on the nature of the continuous model equation (i.e., whether describing the solid motion or the fluid motion), the differencing scheme used, the cell topology and the coordinates of the face intersection points. Thus, in particular, the physical attributes of the medium, such as thermal conductivity, density, Young's modulus, Poisson's Ratio or modulus of elasticity for a solid cell, or such as kinematic viscosity, density, thermal conductivity or specific heat for a fluid cell, are embedded in these coefficients. From the computer's perspective, for each cell these coefficients are fixed constants and the solution process is identical, regardless of whether the cell is solid or fluid.

Step 9: The quantities T_{W}, Tₑ, Tₛ and Tₙ in equation (1) or (2) are approximated using an appropriate interpolation scheme based on neighbouring nodal and/or centroid values. These terms are taken to the right-hand side of the equation, and equation (1) or (2) is now approximated by:

a_{cc}T_{cc}=S_{cc}−a_{w}T_{w}*−aₑTₑ*−aₛTₛ*−aₙTₙ* (3)

where the superscript * refers to the approximate value obtained from the interpolation above.

Step 10: Equation (3) is solved for the quantity T_{cc}:

$${T}_{cc} = \frac{{S}_{cc} - {a}_{w} {T}_{w}^{*} - {a}_{e} {T}_{e}^{*} - {a}_{s} {T}_{s}^{*} - {a}_{n} {T}_{n}^{*}}{{a}_{cc}} \qquad ( 4 )$$

Step 11: Repeat Steps 8-10 for each cell surrounding P, obtaining the value of T at all surrounding cell centres.

Step 12: Determine the value of T at node P by interpolation of the surrounding cell centre values.

Step 13: Select a new node P in the mesh and repeat Steps 8-12. Continue until all nodes in the mesh have been updated. This completes one sweep of the mesh.

The solution process described above is iterative. Nodal values are repeatedly updated until some prescribed convergence criterion is satisfied.

### Partial Differential Equations Solution Procedure

The CCFDM system thus provides a preferred partial differential equations procedure shown in the process algorithms of FIG. 4. P is a typical node in the domain at which the dependent variable is to be evaluated. The PDE solution procedure is as follows:

a. find all the cells that share the current node (i.e. node P) (410).
b. for each one of these cells;

i. calculate and store the cc coordinates, the coordinates of w, s, e and n intersections, the distances from w, s, e and n to the cc coordinates and to the vertices of the triangle faces on which they lie.

ii. calculate Tₑ by weighted averaging between the two cc's that share e (i.e. cc1 and cc2). Similarly, evaluate Tₙ, T_{w} and Tₛ lie.

iii. evaluate T_{cc} from the discretized CCFDM form of the model equation.

c. update node P by weighted averaging from all adjacent cell centres.

The calculations start with an initial guess at P, which is then updated iteratively until the convergence criterion is satisfied.

### Extension of CCFDM Formulation to 3D

To demonstrate the extension of the CCFDM to 3-dimensional problems consider, for example, the tetrahedral cell shown in FIG. 11. Each face of this 4-faced volume element is triangular in shape. To simplify the discussion, the global Cartesian coordinate system is placed with its origin at one of the vertices of the tetrahedron OABC. Face OAB lies in the xy-plane, face OBC lies in the yz-plane and face OCA lies in the xz-plane.

For 3-dimensional problems, the typical CCFDM procedure is as follows:

1. Given the coordinates of A, B and C, calculate the coordinates of the centroid cc of the cell.
2. Draw a line through cc parallel to the z-axis, extending it until it intersects two faces of the cell, at points n (on face ABC) and s (on face OAB) in the figure. Determine the coordinates of n and s.
3. Draw a line through cc parallel to the y-axis, extending it until it intersects two faces of the cell, at points w (on face OCA) and e (on face ABC) in the figure. Determine the coordinates of w and e.
4. Draw a line through cc parallel to the x-axis, extending it until it intersects two faces of the cell, at points f (on face ABC) and b (on face OBC) in the figure. Determine the coordinates off and b.
5. Use three 1D mappings to map the non-uniform stencil in the physical domain to a computational stencil which has uniform spacing in each direction.
6. Apply the appropriate finite difference formulas at the cell centroid to discretize the governing PDEs.
7. Use interpolation formulae to evaluate the dependent variables at the points n, s, w, e, f and b.
8. Use the values obtained in #7 and the discretized equations in #6 to determine the values of the dependent variables at the cell centroid.

To determine the solution at a node in 3D space, all cells that share that node are first identified. The above CCFDM procedure is applied to each of these cells to determine the values at the centroids of these cells. Then, a weighted average of the cell centroid values can be used to determine the nodal value.

### Vertex-Centered Finite Difference Method

Reference is now made to FIGS. 12 and 13 to illustrate the applicant's improved Vertex-Centered Finite Difference Method (VCFDM) numerical approximation process. In a preferred method, a given Partial Differential Equation (PDE), or system of PDEs may be solved using a mesh arrangement containing elements or cells 1310. In the VCFDM methodology, cells are grouped together around a common vertex to form a larger cell, and the discretization process is applied at this common vertex.

Step 1: Create a mesh for the region of interest, similar or identical to the mesh created for the iterative solution of CCFDM, described above. Label all nodes N0, N1, N2, etc. (FIG. 6). Establish a fixed reference frame Oxy. Line segments N1-N2, N2-N3, - - - , N6-N7 form the interface boundary curve between the solid material (solid region) and the fluid material (fluid region) depicted in this model. The mesh in the model can be arbitrary or user influenced, e.g., the user can apply a finer mesh (smaller size cells) in the areas of the model where variables have high gradients. The finer mesh will result in higher resolution in those areas.

Step 2: Select any node in the mesh, and determine the cells sharing that node (FIG. 12, 1210). For example, in the diagram below, P is a node in the solid region and Q is a node in the fluid region. The cells surrounding P are P-N1-N4, P-N4-N6, P-N6-N7-N8-N9, etc. (as shown in FIG. 7). The cells surrounding Q are Q-N17-N24-N25, Q-N25-N26-N19, Q-N19-N6-N5 and Q-N5-N4-N17.

Step 3: Group together all of the cells surrounding node P (or Q) to form one larger cell having a common vertex at node P (or Q) (FIG. 12, 1220). For example, node P is the vertex of the larger cell defined by faces N1-N4-N6 N13-N1. For node Q, node Q is the vertex of the larger cell defined by faces N4-N17-N24-N25-N26-N19-N6-N5-N4.

Step 4: Within the larger cell create a stencil 1410 centred at the vertex at node P (or Q) with arms parallel to the x, y, coordinate directions defined by the fixed reference frame, intersecting the faces of the larger cell at points w, e, s and n(FIG. 14).

Step 5: For the larger cell having the common vertex at node P (or Q), determine and store the coordinates of the face intersection points w, e, s and n, the distances from w, s, e and n to the vertex at node P (or Q), and the distances from w, e, s, and n to the vertices of the faces on which they lie. For example, for the vertex at node P, w lies on face N1-N13, e lies on face N8-N7, s lies on face N5-N4, and n lies on face N11-N12 (FIG. 14).

Step 6: Repeat Steps 2-5 for all nodes in the mesh.

Step 7: Select a node P in the mesh at which the dependent variable (T) is to be evaluated. This node P may be in the solid region, in the fluid region, or on the interface boundary curve.

Step 8: For the vertex at node P (or Q), apply the appropriate mathematical equation (e.g., PDE for solids, or PDE for fluids), defined by the medium in which the vertex at node P (or Q) lies. Approximate the continuous derivatives in the mathematical equations by standard finite difference formulae, applied on the stencils created in Step 4, to formulate a discrete approximation to the continuous equations (FIG. 12, 1230). For the vertex at node P (or Q), this will result in a finite difference equation of the form:

aₚTₚ+a_{w}T_{w}+aₑTₑ+aₛTₛ+aₙTₙ=Sₚ (5)

if the cell is a solid cell, and of the same mathematical form as (5), namely

aₚTₚ+a_{w}T_{w}+aₑTₑ+aₛTₛ+aₙTₙ=Sₚ (6)

if P (or Q) is in the fluid region. In these equations the subscripts p, w, etc., refer to the node P (or Q), face intersection point w, etc. The coefficients aₚ, a_{w}, aₑ, aₛ, aₙ and the source term Sₚ in equations (5) and (6) are not the same. These quantities depend on the nature of the continuous model equation (i.e., whether describing the solid motion or the fluid motion), the differencing scheme used, the cell topology and the coordinates of the face intersection points. Thus, in particular, the physical attributes of the medium, such as thermal conductivity, density, Young's modulus, Poisson's Ratio or modulus of elasticity for a solid cell, or such as kinematic viscosity, density, thermal conductivity or specific heat for a fluid cell, are embedded in these coefficients. From the computer's perspective, for each cell these coefficients are fixed constants and the solution process is identical, regardless of whether the cell is solid or fluid.

Step 9: The quantities T_{w}, Tₑ, Tₛ and Tₙ in equation (5) or (6) are approximated using an appropriate interpolation scheme based on neighbouring vertex values. These terms are taken to the right-hand side of the equation, and equation (5) or (6) is now approximated by

aₚTₚ=Sₚ−a_{w}T_{w}*−aₑTₑ*−aₛTₛ*−aₙTₙ* (7)

where the superscript * refers to the approximate value obtained from the interpolation above.

Step 10: Equation (7) is solved for the quantity Tₚ:

$${T}_{p} = \frac{{S}_{p} - {a}_{w} {T}_{w}^{*} - {a}_{e} {T}_{e}^{*} - {a}_{s} {T}_{s}^{*} - {a}_{n} {T}_{n}^{*}}{{a}_{p}} \qquad ( 8 )$$

Step 11: Select a new node P in the mesh and repeat Steps 8-10. Continue until all nodes in the mesh have been updated. This completes one sweep of the mesh.

The solution process described above is iterative. Nodal values are repeatedly updated until some prescribed convergence criterion is satisfied.

### Partial Differential Equations Solution Procedure

The present system thus provides a preferred partial differential equations procedure shown in the process algorithm of FIG. 12. P is a typical node in the domain at which the dependent variable is to be evaluated. The PDE solution procedure is as follows:

a. find all the cells that share the current node (i.e. node P) (1210);

b. for the complete polygon enclosing the vertex P;
i. calculate and store the coordinates of w, s, e and n intersections, the distances from w, s, e and n to P and to the vertices of the polygon faces on which they lie.
ii. calculate T_{w}, Tₑ, Tₛ and Tₙ, by weighted average of neighboring vertex values.
iii. evaluate Tₚ from the discretized VCFDM form of the PDE.
   The calculations start with an initial guess at P, which is then updated iteratively until the convergence criterion is satisfied.

Comparing the CCFDM and VCFDM procedures, we see that step c (updating node P by weighted averaging from all adjacent cell centres) has been eliminated. Since Tₚ is evaluated directly from the difference equation in the VCFDM methodology, it will be more accurate than the averaging method used in CCFDM. Further, as shown in FIG. 13 in contrast to FIG. 5, the calculations needed for all of the 7 cells of FIG. 5 have been replaced by similar calculations at only one point in FIG. 13, that is, at the vertex P (steps 1220, 1230, FIG. 12). This will result in significant speedup of the overall computation and a large reduction in computer storage requirements.

Applying the VCFDM approach at the common vertex of the collection of triangles (in general, these surrounding cells could be any shape) to the system of differential equations:

DT=S(x,y)

where D is a differential operator and S(x,y) are source terms, and using 3-point central differencing to approximate the partial derivatives in the equation, the resulting difference equation can be written as:

aₚTₚ=a_{w}T_{w}−aₑTₑ−aₛTₛ−aₙTₙ+Sₚ

where the coefficients include the physical Cartesian coordinates of the w, e, s and n points. This equation can be solved iteratively for the value of T at the vertex, assuming we have previous iteration values for T_{w}, Tₑ, Tₛ and Tₙ.

The procedure described above can be implemented on any arbitrary cell topology, i.e. any polyhedral shape, and any combination of cell shapes.

### Extension of VCFDM Formulation to 3D

The extension of the VCFDM to 3-dimensional problems is straightforward and much simpler than the CCFDM. To apply the VCFDM to 3-dimensional problems, all cells that share a node are first identified. With reference to FIG. 15, tetrahedrons ABCO, BDCO, DECO, and EACO all share a common node at origin O. The system of differential equations can then be solved with respect to that node. The benefits of the lower computational cost and memory requirements will manifest itself more prominently in the case of 3D simulations.

Embodiments of the invention may include various steps as set forth above. While described in a particular order, it should be understood that a different order may be taken, as would be understood by a person skilled in the art. Furthermore, the steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

As well, the procedure described above can be implemented on any arbitrary cell topology, ie., any polyhedral shape, and any combination of cell shapes, referred to as hybrid meshes.

The VCFDM method described above is designed to be applicable to a number of physical problems that can be mathematically modeled by partial differential equations with associated initial conditions (for time-dependent problems) and/or boundary conditions. These include, but are not limited to providing output data and/or the manual or automated computer modeling and/or control of at least the following potential applications:
steady and unsteady fluid and gas flows
multi-component and multiphase fluid flows
solid mechanics, elasticity, stress analysis
heat conduction
fluid flow and heat transfer
scour simulations)
sediment transport
electrostatics, electromagnetics
fluid-structure interaction
multiphysics simulations
cardiovascular flows
higher-order numerical schemes
direct numerical simulation of turbulence

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein. Furthermore, the various features and embodiments of the invention may be combined or used in conjunction with other features and embodiments of the invention as described and illustrated herein. The scope of the claims should not be limited to the preferred embodiments set forth in the examples, but should be given the broadest interpretation consistent with the description as a whole.

As used herein, the aforementioned acronyms shall have the following meanings:
PDE—Partial Differential Equation
TFDM—Traditional Finite Difference Methodology
CCFDM—Cell-Centered Finite Difference Methodology
CCFVM—Cell-Centered Finite Volume Methodology
VCFVM—Vertex-Centered Finite Volume Methodology
CV—Control Volume
FEM—Finite Element Methodology
VCFDM—Vertex-Centered Finite Difference Methodology

The embodiments of the invention in which an exclusive property or privilege is claimed is defined as follows:

1. A system for determining fluid flow of compressible and non-compressible liquids, the system comprising:
input means for receiving a model of an object defined as a plurality of cells having a plurality of nodes P;
a processor coupled to a memory, the processor configured for implementing the steps of:
discretizing a partial differential equation corresponding to the received model of the object;
for each node P in the plurality of nodes P:
i. locating at least two neighbouring cells that share the node P;
ii. grouping the at least two neighbouring cells to form one larger cell having a common vertex at node P;
iii. approximating the partial differential equation at the common vertex at node P using the discretized partial differential equation; and
iteratively updating the solution for all the nodes P from an initial guess until a convergence criterion is satisfied.

2. The system of claim 1, wherein the steps of locating and grouping at least two neighbouring cells comprise locating and grouping all of the neighbouring cells that share the node P.

3. The system of claim 2, wherein in the step of approximating the partial differential equation at the common vertex at node P using the discretized partial differential equation, the processor is further configured for:
calculating the coordinates of the common vertex at node P and each of the coordinates at w, s, e and n intersections of the larger cell;
calculating a solution of the partial differential equation at each of the w, s, e, and n intersections; and
approximating the partial differential equation at the common vertex at node P using the discretized partial differential equation, wherein the discretized partial differential equation includes the calculated solution of the partial differential equation at each of the w, s, e, and n intersections.

4. The system of claim 3, wherein the model of the object is in two dimensions.

5. The system of claim 3, wherein the model of the object is in three dimensions and the w, s, e, and n intersections further includes f and b intersections.

6. The system of claim 2, wherein the discretized partial differential equation is a difference equation.

7. A computer-implemented method for approximating a partial differential equation for determining fluid flow of compressible and non-compressible liquids, the method comprising:
discretizing the partial differential equation;
receiving a model of an object defined as a plurality of cells having a plurality of nodes P;
for each node P in the plurality of nodes P:
i. locating at least two neighbouring cells that share the node P;
ii. grouping the at least two neighbouring cells to form one larger cell having a common vertex at node P;
iii. approximating the partial differential equation at the common vertex at node P using the discretized partial differential equation; and
iteratively updating the solution for all the nodes P from an initial guess until a convergence criterion is satisfied.

8. The computer-implemented method of claim 7, wherein the steps of locating and grouping at least two neighbouring cells comprise locating and grouping substantially all of the neighbouring cells that share the node P.

9. The computer-implemented method of claim 8, wherein the step of approximating the partial differential equation at the common vertex of the node P using the discretized partial differential equation includes:
calculating the coordinates of the common vertex at node P and each of the coordinates at w, s, e and n intersections of the larger cell;
calculating a solution of the partial differential equation at each of the w, s, e, and n intersections; and
approximating the partial differential equation at the common vertex at node P using the discretized partial differential equation, wherein the discretized partial differential equation includes the calculated solution of the partial differential equation at each of the w, s, e, and n intersections.

10. The system of claim 9, wherein the model of the object is in two dimensions.

11. The system of claim 9, wherein the model of the object is in three dimensions and the w, s, e, and n intersections further includes f and b intersections.

12. The computer-implemented method of claim 8, wherein the discretized partial differential equation is a difference equation.

13. A computer readable medium having instructions stored thereon that when executed by a computer implement a method for approximating a partial differential equation for determining fluid flow of compressible and non-compressible liquids, the method comprising:
discretizing the partial differential equation;
receiving a model of an object defined as a plurality of cells having a plurality of nodes P;
for each node P in the plurality of nodes P:
i. locating at least two neighbouring cells that share the node P;
ii. grouping the at least two neighbouring cells to form one larger cell having a common vertex at node P;
iii. approximating the partial differential equation at the common vertex at node P using the discretized partial differential equation; and
iteratively updating the solution for all the nodes P from an initial guess until a convergence criterion is satisfied.

14. The computer readable medium of claim 13, wherein the steps of locating and grouping at least two neighbouring cells further comprise locating and grouping all of the neighbouring cells that share the node P.

15. A computer readable medium of claim 14, wherein the step of approximating the partial differential equation at the common vertex at node P using the discretized partial differential equation includes:
calculating the coordinates of the common vertex at node P and each of the coordinates of w, s, e and n intersections of the larger cell;
calculating a solution of the partial differential equation at each of the w, s, e, and n intersections; and
approximating the partial differential equation at the common vertex at node P using the discretized partial differential equation, wherein the discretized partial differential equation includes the calculated solution of the partial differential equation at each of the w, s, e, and n intersections.

16. The computer readable medium of claim 15, wherein the model of the object is in three dimensions and the w, s, e, and n intersections further includes f and b intersections.

17. A computer readable medium of claim 13, wherein the discretized partial differential equation is a difference equation.

18. A computer readable medium of claim 16, wherein the discretized partial differential equation is a difference equation.
